(19) United States
(12) Patent Application Publication
(10) Pub. No.: US 2007/0249789 A1
(43) Pub. Date: Oct. 25, 2007

(54) Transparent polyamide molding compositions

(75) Inventors: Friedrich Severin Buehler, Thusis (CH); Nikolai Lamberts, Bonaduz (CH); Ralf Hala, Lindenberg (DE); Botho Hoffmann, Domat/Ems (CH)

Correspondence Address: SUGHRUE MION, PLLC, 2100 PENNSYLVANIA AVENUE, N.W., SUITE 800, WASHINGTON, DC, 20037, US

(73) Assignee: EMS-CHEMIE AG, Domat/Ems (CH)

(21) Appl. No.: 11/785,842

(22) Filed: Apr. 20, 2007

(30) Foreign Application Priority Data
Apr. 21, 2006 (EP) 06 112 935.9

(51) Int. Cl. C08G 69/48

(52) U.S. Cl. 525/420

(57) ABSTRACT

A polyamide molding composition is described, comprising at least one transparent homopolyamide and/or copolyamide in a proportion by weight of from 70 to 99% by weight; at least one further polymer in a proportion by weight of from 1 to 30% by weight; and also optionally further dyes and/or additives. The polyamide molding composition is one wherein the further polymer is a polyesteramide, and wherein the light transmittance to ASTM D1003 of a sheet of thickness 2 mm produced from the polyamide molding composition is at least 88%, and preferably wherein the notched impact resistance of an article produced therefrom is at least 14 kJ/m².

### TECHNICAL FIELD

The present invention relates to polyamide molding compositions and to articles produced therefrom which are highly transparent and/or which withstand dynamic load, examples being materials for sports equipment and ophthalmic lenses, and also relates to processes for production of these articles.

### PRIOR ART

For the applications mentioned in the introduction, the market demands highly transparent plastics whose light transmittance is above 90% and whose haze values are at most 5%, based on moldings whose wall thickness is 2 mm. At the same time, the intention is that the molding have maximum stiffness, scratch resistance, abrasion resistance, chemicals resistance, toughness, and ability to withstand dynamic load.

Stiff and scratch-resistant materials generally have low toughness and little ability to withstand dynamic load, mineral glass being an example. Tough materials that can withstand dynamic load are generally soft and elastic, an example being rubber. Attempts are frequently made to establish a suitable compromise via mixing of glassy and rubbery polymers.

If transparency is unimportant, the object can be achieved via compounding of these polymers, which if necessary comprise a suitable compatibilizer, to improve the compatibility of the two components.

US-A-2004/0242774 proposes, by way of example, elastomeric additives for semicrystalline polyamides to improve hydrolysis resistance. Polyamide elastomers proposed comprise polyetheramides having from 15 to 85% of defined polyether blocks, the amount of these added to the polyamide being at most 50%. The polyamide used is preferably PA12. This method cannot produce transparent moldings.

EP-A-0389998 describes the impact-modification of amorphous, in particular pigmented, polyamides with polyetheresteramides and with polyetheramides. The amorphous polyamides contain aromatic dicarboxylic acids and with PA12 by way of example do not form transparent blends. Correspondingly, the polyetheramides and polyetheresteramides used contain polyamide segments composed of PA6 and PA66, these do not give transparent products with nylon-12 or with amorphous transparent polyamides.

JP 62161854 describes non-transparent polyamide blends, preferably based on PA6 and PA12, with aliphatic polyesteramides, these having PA6 segments, PA11 segments, or PA12 segments, and also polycaprolactone segments. There is no description of an improvement in notched impact resistance or of the presence of high-specification transparency.

U.S. Pat. No. 5,321,099 describes and claims blends based on specific semicrystalline polyamides (derived from MDI, diphenylmethane 4,4′-diisocyanate) and segmented polyesteramides. These blends are non-transparent.

U.S. Pat. No. 4,346,024 also compounds non-transparent semicrystalline polyamides (e.g. PA 66) with polyester-amides, whereupon disperse phases form. The polyester segments of the polyesteramides used are based inter alia on dimerized fatty acid.

EP-A-0 922 731 uses addition of polyesteramides to improve properties in relation to permeability to light and buckling strength, in foils composed of semicrystalline polyamides (PA6, PA66), their crystallinity being increased via addition of crystallization agents, simply in order to obtain orientable materials. Polyamides mentioned therein comprise PA6 and PA66, and these polyamides are known to be semicrystalline and intrinsically non-transparent, even when, for example, as stated in the inventive example, a crystallization accelerator is added. The possible polyesteramide components cited comprise a very large number of possible systems, but there is no statement or evidence provided here of particular preferences, other than an example with a system based on 60% by weight of caprolactam and 40% by weight of equal parts of 1,4-butanediol and adipic acid.

This document EP-A-0 922 731 speaks of improved transparency and buckling strength. Although the foils composed of these materials are described as transparent, it is quite obvious that this means permeability to light and not actually transparency which would be suitable for the applications proposed here. Specifically, the haze values actually cited in EP-A-0 922 731 are at best 5.6, and this is measured at a very low layer thickness of only 50 μm (foil), i.e. the systems proposed in said document are not actually transparent systems but instead at best systems permeable to light.

If a mixture (blend) is intended to permit production of moldings with high-specification transparency, it has to be possible to mix the components homogeneously, or the components have to be in very fine dispersion in one another, in order that no light scattering can occur.

Most polymers are not homogeneously miscible. Polymer mixtures which give moldings with high-specification transparency are very rare, and those that can give high-transparency moldings whose haze values are at most 5% are likewise rare and in each case can be discovered only empirically, because it is impossible to predict the result of mixing. This is especially not possible if the components have very different structure and very different properties.

By way of example, US-A-2002/0173596 describes transparent polyamide blends. It describes transparent, impact-resistant polyamide blends composed of 50% of semicrystalline polyamide, from 0 to 40% of polyetheramide, and from 5 to 40% of amorphous polyamide, and of further compatibilizers and modifiers. Sufficient transparency >80% appears to be achieved for moldings whose thickness is 2 mm. Said molding composition is intended to permit production of foils with sufficient transparency for use as topcoat for skis. The decorative effect is applied on that side of the foil facing toward the ski and is intended to be discernible on the upper side. The disclosure does not reveal whether molding compositions permit production of moldings whose transparency is above 90% per 2 mm.

WO-A-2004/037898 describes transparent copolymers composed of polyamide blocks and of polyether segments. The polyether segments contain polytetramethylene glycol whose average molar mass is from 200 to 4000 g/mol. The polyamide blocks primarily contain semicrystalline, linear aliphatic fractions and a sufficient amount of comonomers to reduce crystallinity. This gives copolyamides whose Shore D hardness is from 40 to 70 and which have polyether block contents of from 10 to 40% by weight. These materials have very low modulus of elasticity and are too soft for production of transparent lenses, sheets, soles, etc. The transparency values measured are 84% for 2 mm layer thickness, and are too low for many high-specification applications. Nothing is said about haze.

### BRIEF DESCRIPTION OF THE INVENTION

The invention is therefore particularly based on the object of proposing an improved material for use as polyamide molding composition, particularly for high-specification optical applications. The issue here is improvement in a polyamide molding composition comprising at least one transparent homopolyamide and/or copolyamide, particularly preferably in a proportion by weight of from 70 to 99% by weight, and also comprising at least one further polymer, particularly preferably in a proportion by weight of from 1 to 30% by weight, and also optionally comprising further dyes and/or additives.

This object is in particular achieved in that the further polymer is a polyesteramide, and in that the light transmittance of a sheet of thickness 2 mm produced from the polyamide molding composition is at least 88%.

In other words, therefore, the intention is to improve the notched impact resistance of the preferably amorphous or microcrystalline polyamides with maximum retention of (or even an increase in) transparency. This means that the polyamides proposed themselves inherently have high transparency and in principle there is no need for any modification of said component, e.g. addition of specific additives, in order to make a further improvement in this very good transparency or simply to bring it about. The intention is, however, that the polyesteramides added do not impair transparency but ideally merely increase toughness. The acceptable lower limit for light transmittance of the polymer mixture is therefore 88%, this being measured at the considerable layer thickness of 2 mm.

As explained previously, EP-A-0 922 731 at first glance proposes transparent systems, but on closer inspection it is found that these have properties substantially different from those demanded and claimed here. The haze values cited in EP-A-0 922 731 are at best 5.6 at very low layer thickness: only 50 μm (foil). The values measured for haze by the same method for the systems proposed here, i.e. for systems in which light transmittance is at least 88% for a sheet of thickness 2 mm, are smaller than 5 at a thickness many times greater than 2 mm. This corresponds to a factor of 40 in relation to the layer thickness on which the measurement is based. However, this means that the polymer mixtures specifically listed in EP-A-0 922 731 are very certainly no longer transparent for the purposes of the present invention at a layer thickness of 2 mm (i.e. the light transmittance of a sheet of thickness 2 mm produced from the polyamide molding composition is certainly not at least 88), and indeed they can hardly be said to be translucent.

The kernel of the invention therefore consists in the surprising discovery that addition of polyesteramide does not adversely affect the transparency of the parent substance (transparent homopolyamide and/or copolyamide) and moreover can substantially improve further properties, in particular mechanical stability and/or ability to withstand dynamic load, for high-specification applications, i.e. for high-specification transparent components based on polyamide.

The expression transparent polyamides (i.e. transparent homopolyamide and/or copolyamide) used in this specification is intended to indicate polyamides or copolyamides and, respectively, molding compositions formed therefrom, where the light transmittance of these is at least 80%, particularly preferably 90%, if the (co)polyamide (in unmodified form, i.e. without the further constituents stated of the inventive molding composition) takes the form of a plaque of thickness 2 mm. For the purposes of this text, the light transmittance value here is that determined by the ASTM D1003 method (CIE-C illuminant). In the experiments given below, this light transmittance was measured on 70×2 mm disks on haze-gard plus equipment from BYK Gardner (DE). The transmittance value is stated for the visible wavelength region defined as in CIE-C, i.e. with substantial intensities approximately from 400 to 770 nm. The 70×2 mm disks for this purpose are by way of example produced in a polished mold on an Arburg injection-molding machine, the cylinder temperature being from 200 to 340° C. and the mold temperature being from 20 to 140° C.

The haze of a sheet of thickness 2 mm produced from the polyamide molding composition is preferably at most 10, with preference at most 7, particularly preferably at most 5 (measured to ASTM D1003 as stated above).

Surprisingly, it is also found that addition of polyesteramide reduces the possible processing temperatures when comparison is made with the unmodified transparent polyamide. The molding compositions can therefore be processed under milder conditions.

It is moreover found that articles produced from the polyamide molding compositions proposed have substantially lower yellowness index at a layer thickness of 2 mm.

Whereas comparative examples typically exhibit a yellowness index (ASTM D1965, C2 illuminant, again measured on 70×2 mm disks) in the region of at least 5, the polyamide molding compositions proposed can be used to produce sheets whose yellowness index is less than 3, preferably less than 2.5, and particularly preferably less than 2, at a layer thickness of 2 mm.

Examples of transparent polyamides that can be used for this purpose are the polyamides and/or copolyamides described in EP-A-1369447, DE-A-101 22 188, EP-A-725101, EP-A-0837087 or in EP-A-0 725 100, or a mixture thereof. In relation to the transparent polyamides, the disclosure of said documents and the polyamide systems and copolyamide systems mentioned therein are expressly incorporated into this description by way of reference.

In a first preferred embodiment, the light transmittance of the sheet is at least 90%, particularly preferably at least 91%.

The haze value of the sheet is preferably at most 5%, with preference less than 5% (ASTM 1003, layer thickness 2 mm). Haze values of at most 4% or at most 3% are particularly preferred.

Surprisingly, it is found that addition of polyesteramide can increase particularly the impact resistance, and very particularly the notched impact resistance, to a surprisingly great extent. Correspondingly, in an inventive embodiment to which further preference is given, the notched impact resistance of the polyamide molding composition or of an article produced therefrom is at least 14 kJ/m², preferably more than 14 kJ/m², particularly preferably more than 15 kJ/m²

The light transmittance of a sheet whose thickness is 2 mm produced from the transparent homopolyamide and/or copolyamide (i.e. without polyesteramide) is preferably at least 80%, particularly preferably at least 90%. This is preferably the meaning of the expression transparent homopolyamide and/or copolyamide for the purposes of the inventive blend.

In another preferred embodiment, the polyamide molding composition is free from photochromic dyes. It can moreover be freed from dyes of any kind.

In another preferred embodiment, the solution viscosity (ηᵣₑₗ) of the transparent homopolyamide and/or copolyamide is from 1.3 to 2.0, particularly preferably from 1.40 to 1.90. The glass transition temperature T_{g} of the transparent, homopolyamide and/or copolyamide is preferably above 90° C., with preference above 110° C., particularly preferably above 130° C.

Another preferred embodiment is one wherein the solution viscosity (ηᵣₑₗ) of the polyesteramide is more than 1.3, preferably more than 1.4, particularly preferably from 1.45 to 2.0 (to DIN EN ISO 1628-1).

In order to exclude any formation of flow lines and haze, it surprisingly proves advantageous to minimize the difference in the viscosities of homopolyamide (copolyamide) and polyesteramide. Correspondingly, it proves advantageous in one preferred embodiment of the invention that the solution viscosity (ηᵣₑₗ) difference of homopolyamide and/or copolyamide and polyesteramide is less than 0.4, preferably less than 0.3, or less than 0.2.

In another preferred embodiment of the invention, the glass transition temperature of the polyesteramide is less than 40° C., preferably less than 25° C., with particular preference less than 0° C., particularly preferably in the range from (−60) to −(−20)° C. It is likewise preferable that the modulus of elasticity of the polyesteramide is less than 500 MPa, preferably less than 300 MPa, particularly preferably less than 200 MPa. It is preferable that the melting point of the polyesteramide is in the range from 100 to 220° C., preferably from 100 to 180° C., particularly preferably from 100 to 160° C.

In principle, the structure of the polyesteramide has no ether bonds. The polyesteramide here can have a random, alternating, or blockwise arrangement of structural amide units and structural ester units. However, the polyesteramide is preferably a block copolymer which has polyamide blocks and long-chain diol blocks, and/or polyester blocks, in particular polyesterdiol blocks. Express reference is made here to the systems disclosed in EP-A-0 955 326. Said systems are incorporated into the present disclosure by way of reference with regard to the polyesteramide and its preparation process.

In one preferred embodiment, the polyesteramide is a block copolymer based on a polyamide with a long-chain diol and/or polyesterdiol, preferably a dimerdiol, particularly preferably a C36 dimerdiol (by way of example, the product Pripol 2033 from Uniqema, NL). With regard to the dimerdiol, it proves advantageous to provide this in the form of diol which has been derived from a dimeric C36 fatty alcohol whose molar mass is preferably about 550 g/mol and whose diol component preferably amounts to more than 94.5 percent, and whose hydroxide value is from 200 to 215 mg KOH/g. With regard to the diol dimerate, it proves advantageous to form this by derivation from a dimeric C36 fatty acid, particularly preferably one whose molar mass is in the region of 2000 g/mol and whose hydroxide value is from 52 to 60 mg KOH/g. With respect to formation of the diols and of the diol dimerates, express reference is made to the disclosure of EP-A-0 955 326, and specifically to paragraphs [0014] and [0015] therein, the intention being that the disclosure of these be concomitantly incorporated with regard to the nature of the diols and of the diol dimerates.

The block copolymer preferably also contains an aromatic acid, particularly preferably terephthalic acid (TPA), but this can also have been replaced by isophthalic acid (IPA) or naphthalenedicarboxylic acid.

One particularly preferred embodiment of the polyesteramide used is a polyesteramide based on laurolactam, dimerdiol, dimerdiol dimerate, and terephthalic acid. The amounts present of these components are preferably as follows: from 35 to 45% by weight of laurolactam, from 30 to 40% by weight of dimerdiol, preferably C36 dimerdiol (for example the abovementioned Priopol), 5 to 15% by weight of dimerdiol dimerate, particularly preferably C36 diol dimerate (for example the abovementioned Priplast), and also from 5 to 15% by weight of terephthalic acid.

In another preferred embodiment, the proportion by weight present of the transparent homopolyamide and/or copolyamide is from 80 to 98% by weight.

The proportion by weight present of the polyesteramide is preferably from 2 to 20% by weight. It is particularly preferable that the proportion by weight present of the polyesteramide is from 5 to 15% by weight.

The transparent homopolyamide and/or copolyamide is preferably an amorphous or microcrystalline transparent polyamide, particularly one whose modulus of elasticity is more than 1000 MPa.

The following systems are preferred with regard to the transparent homopolyamide and/or copolyamide:

Polyamide based on aliphatic, cycloaliphatic, or aromatic diamines, on dicarboxylic acids, on lactams, and/or on aminocarboxylic acids, preferably having from 6 to 36 carbon atoms, or is a mixture of these homopolyamides and/or copolyamides. The cycloaliphatic diamines here are preferably MACM, IPD, and/or PACM, with or without additional substituents. The aliphatic dicarboxylic acid is preferably an aliphatic dicarboxylic acid having from 2 to 36, preferably from 8 to 20, carbon atoms in linear or branched arrangement, particularly preferably having 10, 12, 14, 16, or 18 carbon atoms.

MACM here is the ISO name for bis(4-amino-3-methylcyclohexyl)methane, which is available commercially with trade name 3,3′-dimethyl-4,4′-diaminodicyclohexylmethane as Laromin C260 grade (CAS No. 6864-37-5), preferably with melting point from −10° C. to 0° C. A numeral as, for example, in MACM12 here represents an aliphatic linear C12 dicarboxylic acid (DDA, dodecanedioc acid), with which the diamine MACM has been polymerized.

IPA is isophthalic acid and PACM is the ISO name for bis(4-aminocyclohexyl)methane, which is available commercially with trade name 4,4′-diaminodicyclohexylmethane as a grade of Dicykan (CAS No. 1761-71-3), preferably with melting point from 30° C. to 45° C.

A homopolyamide selected from the group of MACM12, MACM14, MACM16, MACM18, PACM12, PACM14, PACM16, PACM18, and/or a copolyamide selected from the group of MACM12/PACM12, MACM14/PACM14, MACM16/PACM16, MACM18/PACM18. It is likewise possible to use a mixture of these polyamides.

Polyamide based on aromatic dicarboxylic acids having from 8 to 18, preferably from 8 to 14, carbon atoms, or a mixture of these homopolyamides and/or copolyamides, preferably based on PXDA and/or MXDA, particularly preferably based on lactams and/or on aminocarboxylic acids, where the aromatic dicarboxylic acids are preferably TPA, naphthalenedicarboxylic acid, and/or IPA.

Polyamide selected from the group of: MACM9-18, PACM9-18, MACMI/12, 6I/6T/MACMI/MACMT/12, 3-6T, 6I6T, TMDT, 6I/MACMI/MACMT, 6I/PACMI/PACMT, 6I/6T/MACMI, MACMI/MACM36, 6I; 12/PACMI or 12/MACMI, 12/MACMT, 6IPACMT, 6/6I, 6/IPDT, or a mixture thereof, where 50 mol % of the IPA can have been replaced by TPA.

The additives can be stabilizers, such as non-photochromic dyes, e.g. UV absorbers, UV stabilizers, heat stabilizers, lubricants, for example paraffin waxes or stearates, fillers, or free-radical scavengers, and/or can be processing aids, plasticizers, reinforcing materials, e.g. transparent-dispersion nanoparticles or glass beads or glass fibers, or further polymers, and/or can be functional additives preferably for influencing optical properties, for example particularly refractive index, or can be a combination or mixture thereof.

Examples of further polymers that can be used for the purposes of additives are also polyamides, preferably nylon-12. The amount added of these further polyamides, particularly nylon-12, is preferably in the range from 2 to 15% by weight, particularly preferably in the range from 5 to 10% by weight. Particularly in the case of nylon-12, it proves advantageous that this has been selected in such a way that its solution viscosity is from 1.6 to 2.3, in particular from 1.65 to 1.95 (in each case measured in m-cresol at a concentration of 0.5% by weight at room temperature).

The present invention moreover provides a transparent article with at least one region or one layer composed of a polyamide molding composition as described above. This is particularly preferably a foil, a molding, a profile, a tube, a hollow body, or an optically variable filter, or an optical lens, preferably an ophthalmic lens, particularly preferably an element with spectral filter effect, e.g. in the form of spectacle lens, sun lens, corrective lens, optical filter, ski goggles, visor, safety spectacles, photo-recording, display, optical data storage, or window in buildings or in vehicles, or is a decorative element or a structural element, e.g. in the form of a spectacle frame, toy, or in the form of part of a sports shoe, or cover, in particular in the form of a mobile-telephone casing, a part of electronic equipment, a coating, in particular of packaging, of decorative items, or of sports equipment, or cladding, preferably in the automobile sector. The article can have a color, in particular a color gradient, an antireflective coating, a scratch-resistant coating, an optical-filter coating, a polarizing coating, an oxygen-barrier coating, or a combination of these coatings.

The article is preferably one wherein the glass transition temperature of the region or the layer composed of the polyamide molding composition is above 90° C., preferably above 100° C., particularly preferably above 130° C.

The present invention also provides a process for preparation of a polyamide molding composition as described above. The process is in particular one which comprises mixing the homopolyamide and/or copolyamide, and also the polyesteramide in the form of pellets and molding them in an extruder with melt temperatures in the range from 220 to 350° C. to give an extrudate and chopping with suitable pelletizers to give pellets, preferably using a melt filter on the extruder to remove contamination from molding compositions for transparent moldings, suitable melt filters being those that can be constructed from sieves in sheet form or in the form of candle filters, with the possibility, during the compounding process, of adding additives which are desirable for modification of the molding composition, e.g. processing stabilizers, color pigments, UV absorbers, heat stabilizers, flame retardants, other transparent polyamides, or nylon-12.

The present invention further provides a process for production of an article as described above, which comprises molding a polyamide molding composition as described above in an extrusion process, in an injection-blow-molding process, in an injection-molding process, or in an in-mold-coating process, to give the article.

Further preferred embodiments of the present invention are described in the dependent claims.

### METHODS OF CARRYING OUT THE INVENTION

The disclosure provides high-transparency polyamide molding compositions with in particular improved notched impact resistance, and these are suitable for production of optical lenses or sun lenses, and also for applications with high dynamic stress. The high-transparency polyamide molding compositions proposed are composed of a polymer mixture which comprises a transparent polyamide (amorphous or microcrystalline) and which comprises a polyesteramide, preferably in the form of block copolymer having polyester segments and having polyamide segments. These block copolymers can be adjusted to give the inventive molding compositions very low haze values of at most 5% and to eliminate any demixing during injection molding.

The transparent polymer mixtures have high abrasion resistance and high resistance to dynamic load and are suitable inter alia for transparent soles of sports shoes. These sports shoes have complicated mechanical elements within the sole, these being intended to be revealed to the user via transparent soles. The transparency demanded for this purpose is at a very high level: at least 90% per 2 mm. At the same time, the following requirements have to be met: haze at most 5%, Charpy notched impact resistance >14 kJ/m² (ISO 179/2-1eA).

Surprisingly, it has now been found that a combination composed of transparent polyamide (amorphous or microcrystalline PA) and of a suitably matched polyesteramide achieves the high transparency demanded together with low haze and does not show any markings (flow lines) in the region of high shear. Mechanical and thermal properties mainly correspond to those of the amorphous polyamide, but substantially higher toughness is achieved, in particular notched impact resistance.

It is also found that matching of the composition and of the viscosity of the polyesteramide to similar amorphous or microcrystalline, transparent polyamides can give further combinations whose transparency values can be >85, preferably >90%, and whose haze values can be at most 5%.

Polyesteramides of composition 1: a) laurolactam 41.1% by weight, b) Pripol 2033 (dimerdiol, obtainable from Uniqema, NL) 35.8% by weight, c) Priplast 3197 (PES diol, obtainable from Uniqema, NL) 11.2% by weight, and d) terephthalic acid (TPA) 11.7% by weight, prepared with relative viscosity (ηᵣₑₗ) of 1.35, measured at 0.5% in m-cresol, are polymerized by known preparation processes for polyesteramides in vacuo (EP-A-0 955 326, the disclosure of said document being expressly incorporated by way of reference with regard to the polyesteramides and their preparation processes). Compounded with 90% of Grilamid TR 90 (obtainable from EMS-Chemie AG, CH; MACM12, corresponding to a composition of EP-A-0 837 087 or of EP-A-0 725 101, the disclosure of which is hereby expressly incorporated by way of reference with regard to said components and its preparation processes) with ηᵣₑₗ=1.73 to give transparent pellets.

The pellets can be processed in an injection-molding machine to give sheets with 92% transmittance and <2% haze (ASTM 1003, C illuminant, layer thickness 2 mm, measuring instrument: Byk Gardner). In the injection molding here there can sometimes be flow lines arising in the region of the sprue, these indicating demixing of the two polymers. The flow lines and haze in the region of the sprue can be eliminated via adjustment of the relative viscosity of the polyesteramide to ηᵣₑₗ>1.45. As the difference between the relative viscosities of the amorphous polyamide and of the polyesteramide reduces, the tendency toward formation of flow lines or haze in the sprue region reduces.

The polyesteramide with composition 1 as cited above in the form of compounded material with 90% by weight of Grilamid TR FE5537 (EMS-Chemie AG, CH; PACM12/MACM12, corresponding to a composition of EP 1 369 447, the disclosure of which not only with regard to the polyamide but also with regard to its preparation process is expressly incorporated herein by way of reference) exhibits good transparency >90% and even higher notched impact resistance than the combination with 90% by weight of Grilamid TR 90.

In one preferred embodiment, the underlying object is therefore achieved if, for example, stiff, high-transparency polyamides are compounded with flexible, semicrystalline polyesteramides whose melting points are in the region from 100 to 180° C., preferably in the region from 100 to 160° C. In a preferred embodiment, the relative viscosities of the polyamides and of the polyesteramides should differ by less than 0.3 units, in order that no optical artifacts arise in the sprue region of the molding during injection molding.

Particularly suitable stiff high-transparency polyamides are amorphous or microcrystalline transparent polyamides whose moduli of elasticity are above 1000 MPa, and whose glass transition temperature is above 100° C.

These polyamides contain aliphatic, cycloaliphatic, and or aromatic diamines, dicarboxylic acids, and/or lactams, or aminocarboxylic acids. Aliphatic diamines contain from 2 to 20 carbon atoms, the arrangement of which can be linear or branched. Examples of cycloaliphatic units are PACM, MACM, IPD with or without addition of substituents. Examples of aromatic amines are PXDA or MXDA. The possible dicarboxylic acids have comparable structural moieties between the acid groups. Examples of these aromatic dicarboxylic acids are TPA, IPA, or naphthalenedicarboxylic acid. Suitable lactams are lactam 6 or lactam 12, which can be used in the form of rings or in open form as aminocarboxylic acid.

Preferred combinations composed of diamines, of dicarboxylic acids, and of lactams are: MACM9-18, PACM9-18, 6I/6T/MACMI/MACMT/12, 3-6T, or a mixture thereof, and MACMI/12, and PACMI/12, and 50 mol % of the IPA here can have been replaced by TPA.

The modulus of elasticity of the flexible polyesteramides is below 500 MPa, preferably below 300 MPa, in particular below 200 MPa, and their melting points are in the range from 100 to 220° C., preferably from 100 to 180° C., particularly preferably from 100 to 160° C., and their glass transition temperatures are below 0° C., preferably below −20° C.

The transparent polyamides that can be used therefore comprise the following PA compositions:
1. PA composed of cycloaliphatic diamines, preferably of PACM, MACM, and of C8-C36 aliphatic dicarboxylic acids; explicit mention may be made of C10, C12, and C18. Examples of PA are the homopolyamides MACM12, MACM18, or PACM12, or the copolyamides MACM12/PACM12, MACM18/PACM18
2. PA having C8-C14 aromatic dicarboxylic acids, preferably TPA, IPA. The diamines can be aliphatic or cycloaliphatic. Alongside these, it is also possible to use lactams and/or aminocarboxylic acids as monomer. Examples of PA are: 6I6T, TMDT, 6I/MACMI/MACMT, 6I/PACMI/PACMT, 6I/6T/MACMI, MACMI/MACM36; 6I; lactam-containing PA: 12/MACMI or 12/MACMI, 12/MACMT, 6/MACMT, 6/6I, 6/IPDT
3. PA having diamine which has an aromatic ring: e.g. MXDA. The dicarboxylic acids have aromatic and/or aliphatic structure. An example is the copolyamide 6I/MXDI.

Suitable polyesteramides contain lactams, dicarboxylic acids, diamines, and long-chain diols. The long-chain diols used are preferably dimerdiols or polyesterdiols based on dimerdiols. These products are commercially available from Uniqema, NL, with the names Pripol 2033 or Priplast 3197.

The polyamides are prepared in pressure autoclaves by known processes (cf. inter alia the specifications cited at an earlier stage above), and transparent polyamides in particular require a high level of plant cleanliness and of raw material purity. The polyesteramides are prepared in vacuum vessels which are usually used for preparation of polyesters.

For preparation of the inventive compounded materials, the two pelletized materials are mixed and molded at melt temperatures around 220-350° C. in an extruder to give an extrudate, and chopped by suitable pelletizers to give pellets. A melt filter is used in the extruder to remove contamination from molding compositions for transparent moldings. Suitable melt filters can be composed of sieves in the form of disks or in the form of candle filters.

During compounding, it is possible to add further additives desired for modification of the molding composition, examples being processing stabilizers, color pigments, UV absorbers, heat stabilizers, flame retardants, other transparent polyamides, or nylon-12.

The inventive molding compositions can be processed not only by injection molding but also by extrusion processes, to give foils, tubes, profiles, or hollow bodies.

### EXAMPLES E1 TO E5 AND COMPARATIVE EXAMPLES CE1 TO CE5

First, the polymer mixtures composed of transparent polyamide and of a block copolymer were prepared in a Collin Teach-Line ZK25T L/D=18 twin-screw extruder. The barrel temperatures, except in the feed zone, were from 220 to 280° C., and the screw rotation rate was from 120 to 250 rpm.

These mixtures were then processed in an Arburg Allrounder 350-90-220D injection-molding machine to give round plaques of size 70×2 mm (optical tests) and the other test specimens needed, barrel temperature being from 220 to 280° C. and mold temperature being from 20 to 60° C. The screw rotation rate was from 150 to 400 rpm.

The compositions and the properties of the polyamide molding compositions used in each of the inventive examples and those of the comparative examples, are collated in Table 1.

The molding compositions prepared were tested as follows:

### MVR: (melt volume rate) at 275° C. to ISO 1133

### IR: impact resistance to ISO 179/1eU (Charpy)

### NIR: notched impact resistance to ISO 179/1eA (Charpy)

Tensile modulus of elasticity, ultimate tensile strength, and tensile strain at break were determined to ISO 527 on ISO tensile specimens, ISO/CD 3167 standard, type A1, 170×20/10×4 mm at a temperature of 23° C. The mechanical properties were determined in the dry state.

Relative viscosity (ηᵣₑₗ) was determined at 20° C. on a 0.5% strength m-cresol solution to the DIN EN ISO 307 standard.

Transmittance, haze, and clarity were determined at 23° C. using a haze-gard plus from Byk Gardner to ASTM D1003 (CIE C illuminant) on round plaques of size 70×2 mm. Transmittance, clarity, and haze are stated in % of the amount of incident light.

Yellowness index was measured to ASTM D1925 (C2 illuminant) on round plaques of size 70×2 mm.

FE7314 and FE7334 are polyesteramides based on nylon-12 and dimerdiol, these being generally described in EP 0 955 326 B1 (T_{g}=−30° C.)

PEBAX 5533 is a nylon-12 block copolymer having ether segments from ARKEMA, France. (T_{g}=about −40°).

Lotader GMA AX8840 is a polyethylene copolymer having 8% by weight of glycidyl methacrylate from Arkema (FR).

Paraloid BTA 753 is a core-shell impact modifier based on methacrylates, butadiene, and styrene from Rohm & Haas (DE).

MB XE 3680 is a commercial masterbatch based on a low-viscosity nylon-12 with UV stabilizers and heat stabilizers from EMS-Chemie AG, Switzerland.

TABLE 1

| Example | | | | | | | | | |
|---|---|---|---|---|---|---|---|---|---|
| E1 | E2 | E3 | E4 | E5 | CE1 | CE2 | CE3 | CE4 | CE5 |

Compositions

| | | | | | | | | | | | |
|---|---|---|---|---|---|---|---|---|---|---|---|
| TR 90 | % by wt. | 90 | 90 | 85 | 87 | | 100 | 90 | 90 | 84 | 90 |
| FE5537 | % by wt. | | | | | 87 | | | | | |
| FE7334 | % by wt. | 10 | | 15 | | | | | | | |
| FE7314 | % by wt. | | 10 | | 10 | 10 | | | | 10 | |
| Lotader GMA | % by wt. | | | | | | | 10 | | 3 | |
| AZ8840 | | | | | | | | | | | |
| Paraloid BTA 753 | % by wt. | | | | | | | | 10 | | |
| Pebax 5533 | % by wt. | | | | | | | | | | 10 |
| MB PA12 XE | % by wt. | | | | 3 | 3 | | | | 3 | |
| 3680 | | | | | | | | | | | |

Base data

| | | | | | | | | | | | |
|---|---|---|---|---|---|---|---|---|---|---|---|
| Water | % | 0.010 | 0.014 | 0.013 | 0.013 | 0.015 | 0.013 | 0.014 | 0.015 | 0.016 | 0.011 |
| T_{g} | ° C. | 152 | 153 | 152 | 152 | 152 | 153 | 153 | 151 | 153 | 149 |
| MVR 275° C./ | ml/10 min | 25 | 25 | 38 | 24 | 26 | 16 | 13 | 15 | 26 | 25 |
| 5 kg | | | | | | | | | | | |

Optical properties

| | | | | | | | | | | | |
|---|---|---|---|---|---|---|---|---|---|---|---|
| Yellowness index | — | 2.4 | 1.6 | 2.9 | 1.3 | 1.3 | −0.3 | 7.3 | 9.0 | 5.0 | 9.5 |
| ASTM D1925 | | | | | | | | | | | |
| (C2 illuminant) | | | | | | | | | | | |
| Haze ASTM | % | 1.9 | 2.6 | 3.5 | 2.2 | 5.0 | 1.1 | 16.6 | 82.5 | 64.8 | 6.0 |
| D1003 | | | | | | | | | | | |
| Transmittance | % | 93.1 | 93.6 | 92.5 | 93.4 | 91.9 | 93.7 | 86.9 | 72.6 | 81.7 | 88.8 |
| ASTM D1003 | | | | | | | | | | | |
| Clarity | % | 99.5 | 97.9 | 97.5 | 98.3 | 97.8 | 99.5 | 99.1 | 94.8 | 95.1 | 99.5 |

Mechanical properties

| | | | | | | | | | | | |
|---|---|---|---|---|---|---|---|---|---|---|---|
| Tensile modulus | MPa | 1330 | 1330 | 1250 | 1330 | 1310 | 1500 | 1270 | 1280 | 1250 | 1400 |
| Ultimate tensile | MPa | 51 | 52 | 47 | 52 | 50 | 82 | 48 | 48 | 51 | 47 |
| strength | | | | | | | | | | | |
| Tensile strain at | % | 130 | 130 | 130 | 140 | 140 | 150 | 115 | 125 | 145 | 105 |
| break | | | | | | | | | | | |
| Impact resistance | kJ/m² | nf | nf | nf | nf | nf | nf | nf | nf | nf | nf |
| 23° C., | | | | | | | | | | | |
| Charpy new | | | | | | | | | | | |
| Notched impact | kJ/m² | 15.8 | 17.2 | 19.5 | 14.7 | 17.4 | 8.2 | 63.0 | 37.5 | 24.4 | 13.8 |
| resistance | | | | | | | | | | | |
| 23° C., | | | | | | | | | | | |
| Charpy new | | | | | | | | | | | |

### EXAMPLES E6 TO E10

Additional supportive examples 6-10 were manufactured and tested, this time with the additional additive nylon-12, used in the form of GRILAMID L16 in a proportion of from 5 to 10% by weight.

The corresponding results are collated in Table 2, and it appears that addition of from 5 to 10% by weight of this additive can additionally substantially improve mechanical properties, while optical properties in essence remain identical or indeed in some cases are even improved.

TABLE 2

| Example | | | | |
|---|---|---|---|---|
| E6 | E7 | E8 | E9 | E10 |

Compositions

| | | | | | | |
|---|---|---|---|---|---|---|
| GRILAMID TR 90 | % by wt. | 80 | 80 | 80 | 80 | |
| (ηᵣₑₗ = 1.75) | | | | | | |
| GRILAMID TR 90 | % by wt. | | | | | 80 |
| (ηᵣₑₗ = 1.65) | | | | | | |
| FE7314 (ηᵣₑₗ = 1.35) | % by wt. | 10 | 15 | | | |
| FE7314 (ηᵣₑₗ = 1.58) | % by wt. | | | | 10 | 10 |
| FE7311 (ηᵣₑₗ = 1.62) | % by wt. | | | 10 | | |
| GRILAMID L16 | % by wt. | 10 | 5 | 10 | 10 | 10 |
| (ηᵣₑₗ = 1.66) | | | | | | |

Base data

| | | | | | | |
|---|---|---|---|---|---|---|
| Water | % | 0.012 | 0.013 | 0.012 | 0.014 | 0.011 |
| T_{g} | ° C. | 131 | 137 | 128 | 131 | 130 |
| MVR 275° C./5 kg | ml/10 min | 31 | 40 | 44 | 40 | 63 |

Optical properties

| | | | | | | |
|---|---|---|---|---|---|---|
| Sprue marking | — | no | no | no | no | no |
| Yellowness index | — | 3.9 | 5.0 | 2.3 | 3.5 | 3.2 |
| ASTM D1925 | | | | | | |
| (C2 illuminant) | | | | | | |
| Haze ASTM D1003 | % | 2.1 | 3.9 | 0.7 | 3.6 | 1.8 |
| Transmittance | % | 92.7 | 92.3 | 93.3 | 92.9 | 93.1 |
| ASTM D1003 | | | | | | |
| Clarity | % | 99.2 | 94.4 | 99.5 | 96.5 | 98.4 |

Mechanical properties

| | | | | | | |
|---|---|---|---|---|---|---|
| Tensile modulus | MPa | 1430 | 1360 | 1450 | 1420 | 1410 |
| Ultimate tensile | MPa | 52 | 55 | 59 | 56 | 54 |
| strength | | | | | | |
| Tensile strain at | % | 140 | 150 | 180 | 160 | 160 |
| break | | | | | | |
| Impact resistance | kJ/m² | nf | nf | nf | nf | nf |
| 23° C., Charpy new | | | | | | |
| Notched impact | kJ/m² | 15.5 | 16.2 | 14.7 | 14.4 | 14.0 |
| resistance 23° C., | | | | | | |
| Charpy new | | | | | | |

FE7311: polyesteramides based on nylon-12 and dimerdiol; FE 7314 also contains polyester segments based on dimer acid and dimerdiol.

GRILAMID L16 is a low-viscosity nylon-12 whose solution viscosity measured in m-cresol (0.5% by weight) is 1.66.

What is claimed is:

1. A polyamide molding composition comprising
at least one transparent homopolyamide and/or copolyamide in a proportion by weight of from 70 to 99% by weight;
at least one further polymer in a proportion by weight of from 1 to 30% by weight;
and also optionally
further dyes and/or additives,
wherein
the further polymer is a polyesteramide, and
wherein
the light transmittance of a sheet of thickness 2 mm produced from the polyamide molding composition is at least 88%.

2. The polyamide molding composition as claimed in claim 1, wherein the light transmittance of the sheet is at least 90%, preferably at least 91%.

3. The polyamide molding composition as claimed in any of the preceding claims, wherein the haze of the sheet is at most 5%, preferably less than 5%.

4. The polyamide molding composition as claimed in any of the preceding claims, wherein the haze of the sheet is at most 4%, preferably at most 3%.

5. The polyamide molding composition as claimed in any of the preceding claims, wherein the notched impact resistance of the sheet is at least 14 kJ/m², preferably more than 14 kJ/m², particularly preferably more than 15 kJ/m².

6. The polyamide molding composition as claimed in any of the preceding claims, wherein the yellowness index of the sheet is less than 3, preferably less than 2.5, and particularly preferably less than 2.

7. The polyamide molding composition as claimed in any of the preceding claims, wherein the light transmittance of a sheet of thickness 2 mm produced from the transparent homopolyamide and/or copolyamide is at least 90%.

8. The polyamide molding composition as claimed in any of the preceding claims, which is free from photochromic dyes.

9. The polyamide molding composition as claimed in any of the preceding claims, wherein the solution viscosity (ηᵣₑₗ) of the transparent homopolyamide and/or copolyamide is from 1.3 to 2.0, particularly preferably from 1.40 to 1.90, and/or its glass transition temperature T_{g} is above 90° C., preferably above 110° C., particularly preferably above 130° C.

10. The polyamide molding composition according to any of the preceding claims, wherein the solution viscosity (ηᵣₑₗ) of the polyesteramide is more than 1.3, preferably more than 1.4, particularly preferably from 1.45 to 2.0.

11. The polyamide molding composition as claimed in any of the preceding claims, wherein the solution viscosity (ηᵣₑₗ) difference of hompolyamide and/or copolyamide and polyesteramide is less than 0.4, preferably less than 0.3, or less than 0.2.

12. The polyamide molding composition as claimed in any of the preceding claims, wherein the glass transition temperature of the polyesteramide is less than 40° C., preferably less than 25° C., with particular preference less than 0° C., particularly preferably in the range from (−60) to −(−20)° C.

13. The polyamide molding composition as claimed in any of the preceding claims, wherein the modulus of elasticity of the polyesteramide is less than 500 MPa, preferably less than 300 MPa, particularly preferably less than 200 MPa.

14. The polyamide molding composition as claimed in any of the preceding claims, wherein the melting point of the polyesteramide is in the range from 100 to 220° C., preferably from 100 to 180° C., particularly preferably from 100 to 160° C.

15. The polyamide molding composition as claimed in any of the preceding claims, wherein the polyesteramide is a block copolymer.

16. The polyamide molding composition as claimed in any of the preceding claims, wherein the polyesteramide is a block copolymer based on a polyamide with a long-chain diol and/or polyesterdiol, preferably a dimerdiol, particularly preferably a C36 dimerdiol.

17. The polyamide molding composition as claimed in claim 16, wherein the block copolymer also contains dimerdiol dimerate, particularly preferably C36 diol dimerate.

18. The polyamide molding composition as claimed in claim 16 or 17, wherein the block copolymer also contains an aromatic acid, particularly preferably terephthalic acid.

19. The polyamide molding composition as claimed in any of the preceding claims, wherein the basis on which the polyesteramide has been formed comprises an amount in the range from 35 to 45% by weight of laurolactam, from 30 to 40% by weight of dimerdiol, preferably C36 dimerdiol, from 5 to 15% by weight of dimerdiol dimerate, particularly preferably C36 diol dimerate, and also from 5 to 15% by weight of terephthalic acid.

20. The polyamide molding composition as claimed in any of the preceding claims, wherein the proportion present by weight of the transparent homopolyamide and/or copolyamide is from 80 to 98% by weight.

21. The polyamide molding composition as claimed in any of the preceding claims, wherein the proportion present by weight of the polyesteramide is from 2 to 20% by weight.

22. The polyamide molding composition as claimed in any of the preceding claims, wherein the proportion present by weight of the polyesteramide is from 5 to 15% by weight.

23. The polyamide molding composition as claimed in any of the preceding claims, wherein the transparent hompolyamide and/or copolyamide is an amorphous or microcrystalline transparent polyamide, preferably with modulus of elasticity of more than 1000 MPa.

24. The polyamide molding composition as claimed in any of the preceding claims, wherein the transparent homopolyamide and/or copolyamide is a polyamide based on aliphatic, cycloaliphatic, or aromatic diamines, on dicarboxylic acids, on lactams, and/or on aminocarboxylic acids, preferably having from 6 to 36 carbon atoms, or is a mixture of these homopolyamides and/or copolyamides.

25. The polyamide molding composition as claimed in claim 24, wherein the cycloaliphatic diamines are MACM, IPD and/or PACM, with or without addition or substituents.

26. The polyamide molding composition as claimed in claim 24 or 25, wherein the aliphatic dicarboxylic acid is an aliphatic dicarboxylic acid having from 2 to 36, preferably from 8 to 20, carbon atoms in linear or branched arrangement, particularly preferably having 10, 12, 14, 16, or 18 carbon atoms.

27. The polyamide molding composition as claimed in any of claims 24 to 26, wherein the transparent polyamide is a homopolyamide selected from the group of MACM12, MACM14, MACM16, MACM18, PACM12, PACM14, PACM16, PACM18, and/or is a copolyamide selected from the group of MACM12/PACM12, MACM14/PACM14, MACM16/PACM16, MACM18/PACM18, or is a mixture of these polyamides.

28. The polyamide molding composition as claimed in any of claims 24 to 27, wherein the transparent homopolyamide and/or copolyamide is a polyamide based on aromatic dicarboxylic acids having from 8 to 18, preferably from 8 to 14, carbon atoms, or is a mixture of these homopolyamides and/or copolyamides, preferably based on PXDA and/or MXDA, particularly preferably based on lactams and/or on aminocarboxylic acids, where the aromatic dicarboxylic acids are preferably TPA, naphthalenedicarboxylic acid, and/or IPA.

29. The polyamide molding composition as claimed in claim 28, wherein the transparent homopolyamide and/or copolyamide is a polyamide selected from the group of: MACM9-18, PACM9-18, MACMI/12, 6I/6T/MACMI/MACMT/12, 3-6T, 6I6T, TMDT, 6I/MACMI/MACMT, 6I/PACMI/PACMT, 6I/6T/MACMI, MACMI/MACM36, 6I; 12/PACMI or 12/MACMI, 12/MACMT, 6IPACMT, 6/6I, 6/IPDT, or a mixture thereof, where 50 mol % of the IPA can have been replaced by TPA.

30. The polyamide molding composition as claimed in any of the preceding claims, wherein the additives are stabilizers, such as non-photochromic dyes, e.g. UV absorbers, UV stabilizers, heat stabilizers, lubricants, for example paraffin wax or stearates, fillers, or free-radical scavengers, and/or are processing aids, plasticizers, reinforcing materials, e.g. transparent-dispersion nanoparticles or glass beads or glass fibers, further polymers, transparent polyamides, and/or nylon-12, and/or are functional additives preferably for influencing optical properties, for example particularly refractive index, or are a combination or mixture thereof.

31. The polyamide molding composition as claimed in any of the preceding claims, wherein the polyesteramide is a block copolymer based on hard nylon-12 segments with soft C36 dimerdiol segments.

32. A transparent article with at least one region or one layer composed of a polyamide molding composition as claimed in any of the preceding claims.

33. The article as claimed in claim 32, which is a foil, a molding, a profile, a tube, a hollow body, or an optically variable filter, or an optical lens, and preferably is an ophthalmic lens, and particularly preferably is an element with spectral filter effect, for example in the form of spectacle lens, sun lens, corrective lens, optical filter, ski goggles, visor, safety spectacles, photorecording, display, optical data storage, or window in buildings or in vehicles, or is a decorative element or a structural element, e.g. in the form of a spectacle frame, toy, or in the form of part of a sports shoe, or cover, in particular in the form of a mobile-telephone casing, a part of electronic equipment, a coating, in particular of packaging, of decorative items, or of sports equipment, or cladding, preferably in the automobile sector.

34. The article as claimed in either of claims 32 and 33, which has a color gradient, an antireflective coating, a scratch-resistant coating, an optical-filter coating, a polarizing coating, an oxygen-barrier coating, or a combination of these coatings.

35. The article as claimed in any of claims 32 to 34, wherein the glass transition temperature of the region or the layer composed of the polyamide molding composition is above 90° C., preferably above 100° C., particularly preferably above 130° C.

36. A process for preparation of a polyamide molding composition as claimed in any of claims 1 to 31, which comprises mixing the homopolyamide and/or copolyamide, and also the polyesteramide in the form of pellets and molding them in an extruder with melt temperatures in the range from 220 to 350° C. to give an extrudate and chopping with suitable pelletizers to give pellets, preferably using a melt filter on the extruder to remove contamination from molding compositions for transparent moldings, suitable melt filters being those that can be constructed from sieves in sheet form or in the form of candle filters, with the possibility, during the compounding process, of adding additives which are desirable for modification of the molding composition, e.g. processing stabilizers, color pigments, UV absorbers, heat stabilizers, flame retardants, other transparent polyamides, or nylon-12.

37. A process for production of an article as claimed in any of claims 32 to 35, which comprises molding a polyamide molding composition as claimed in any of claims 1 to 31 in an extrusion process, in an injection-blow-molding process, in an injection-molding process, or in an in-mold-coating process, to give the article.
